(19) United States
(12) Patent Application Publication
(10) Pub. No.: US 2011/0098199 A1
(43) Pub. Date: Apr. 28, 2011

(54) Microreactor Array

(76) Inventors: Richard D. Oleschuk, Kingston (CA); Michelle Douma, Kingston (CA)

(21) Appl. No.: 12/884,525

(22) Filed: Sep. 17, 2010

Related U.S. Application Data
(60) Provisional application No. 61/243,598, filed on Sep. 18, 2009.

(51) Int. Cl. C40B 40/00; C40B 40/10; C40B 50/00; C40B 60/00

(52) U.S. Cl. 506/13; 506/18; 506/23; 506/33

(57) ABSTRACT

Provided is a microreactor array, comprising a single fibre comprising a matrix material; a plurality of capillaries formed within the matrix material, the capillaries substantially aligned along a longitudinal axis of the fibre; and one or more reagent associated with an inner surface of the capillaries; wherein each capillary corresponds to a microreactor of the array. Also provided are microreactor array methods and systems, including a manifold microreactor system and a microreactor array system microchip.

### RELATED APPLICATIONS

This application claims the benefit of the filing date of U.S. Provisional Patent Application No. 61/243,598, filed on 18 Sep. 2009, the contents of which are incorporated herein by reference in their entirety.

### FIELD OF THE INVENTION

This invention provides a microreactor array, and methods therefor. In particular, the methods and apparatus provided herein include micro structured fibres as microreactors.

### BACKGROUND

Analysis of chemical samples by techniques such as mass spectrometry often requires pre-treatment of the samples. Pre-treatment may include, e.g., separation of chemical entities, clean-up of the sample, in which unwanted or interfering components are removed, and/or at least partial digestion of certain compounds such as proteins. Samples of biological molecules are often available only in minute quantities and accordingly any pre-treatment of the sample must be able to be completed sparingly and with small sample sizes. Currently available techniques typically used for samples of biological molecules include in solution digestion, packed columns with enzyme laden microspheres, microfluidic devices, and capillaries filled with porous polymer monoliths.

Capillaries may be packed with a material, usually in the form of beads, which is used as a support for chemical moieties such as enzymes, to pre-treat the sample. However, bead packing is not a trivial process and frits are needed to hold the beads in place. Depending on the analysis required, frits may become a hindrance since, for chromatography, they have been shown to cause adsorption and band broadening. They may also introduce considerable backpressure, placing limitations on the sample flow rate.

Alternatively, a column may be fabricated using functionalized silica beads entrapped with porous polymer monolith (PPM). The column may be used as a nanoelectrospray emitter, a solid phase extraction column, or an electrochromatography column (Xie, R., et al., Electrophoresis 2005, 26, 4225-423).

PPM formation as described by Svec and Fréchet (Science 1996, 273, 205-211) has resulted in an alternative to packed columns. In this case, the PPM is directly attached to the wall of a fused-silica capillary and as a result no additional measures for polymer retention are needed. The polarity and the pore size of the PPM can be altered through choice of monomers and porogenic solvent, respectively. However, this technique still produces considerable back pressure.

### SUMMARY

One aspect provides a microreactor array, comprising: a single fibre comprising a matrix material; a plurality of capillaries formed within the matrix material, the capillaries substantially aligned along a longitudinal axis of the fibre; and one or more reagent associated with an inner surface of the capillaries; wherein each capillary corresponds to a microreactor of the array.

Another aspect provides a microreactor array system, comprising a microreactor array as described above and a pump for applying a fluid sample to the array. In one embodiment, the microreactor array may be used as a nanoelectrospray emitter. In this embodiment, a potential difference is applied to the microreactor.

Another aspect provides a method of carrying out a chemical reaction, comprising: providing a single fibre comprising a matrix material and a plurality of capillaries formed within the matrix material, the capillaries substantially aligned along a longitudinal axis of the fibre, wherein each capillary is a microreactor; providing one or more reagent associated with an inner surface of the capillaries; and applying a fluid sample to the capillaries; wherein one or more components of the fluid sample react with the reagent in the capillaries of the fibre.

The method may further comprise applying a potential difference to the microreactor, and producing from the microreactor a nanoelectrospray of the sample

In the above aspects, the capillaries may be arranged in a substantially parallel relationship within the fibre. The fibre may be a microstructured fibre, such as a photonic crystal fibre. The reagent may include at least one enzyme, or at least one catalyst, or combinations thereof.

Also described herein is a microreactor array system, comprising; a manifold that holds at least two microreactor arrays as described herein; at least two said microreactor arrays; a delivery conduit connected to each microreactor array; and a waste conduit connected to each microreactor array.

The microreactor array system may further comprise a collector associated with each microreactor array. The microreactor array system may further comprise a pump for delivering a sample and/or solvent to the microreactor arrays via the delivery conduit.

Also described herein is a microreactor array system microchip, comprising: a substrate; at least one microreactor array as described herein at least partially embedded in the substrate; a sample delivery channel in communication with a proximal end of the microreactor array and at least partially formed in the substrate, for delivering a sample to the microreactor array; a solvent delivery channel in communication with a proximal end of the microreactor array and at least partially formed in the substrate, for delivering a solvent to the microreactor array; a reservoir in communication with a distal end of the microreactor array and at least partially formed in the substrate, for receiving products and/or digests of a reaction and/or digestion carried out in the microreactor array; an electrospray solvent delivery channel in communication with the reservoir and at least partially formed in the substrate, for delivering an electrospray solvent; an electrospray emitter in communication with a distal end of the reservoir and at least partially embedded in the substrate; and an electrode at a distal end of the reservoir, for applying a voltage to the emitter; wherein the emitter produces an electrospray.

In one embodiment the electrospray emitter may be a microstructured fiber (MSF) electrospray emitter.

### BRIEF DESCRIPTION OF THE DRAWINGS

For a better understanding of the invention, and to show more clearly how it may be carried in effect, embodiments will be described below, by way of example, with reference to the accompanying drawings, wherein:

FIG. 1 is a mass spectrometry plot showing digestion of cytochrome c using a microreactor functionalized with trypsin, according to an embodiment of the invention.

FIG. 2 is a diagram of a microreactor array system according to one embodiments;

FIG. 3 is a diagram of a microreactor array system implemented in a microchip format according to another embodiment.

### DETAILED DESCRIPTION OF EMBODIMENTS

Described herein is a microreactor array including a plurality of separate or distinct capillaries, each capillary being one microreactor. The inside wall of each capillary is functionalized with a material including at least one reagent, such as, for example, an enzyme or a catalyst. Combinations of reagents may be used. A sample is passed through the capillary, and one or more components in the sample may react with the one or more reagent. The capillaries in the array may be bundled or grouped together in a substantially parallel arrangement.

In one embodiment, the microreactor array may include a body made of a matrix material, and a plurality of capillaries formed through the matrix material of the body, each capillary being one reactor of the array of microreactors. The capillaries may be arranged in a substantially parallel relationship within the body.

For example, the capillaries may be formed together, as a set of capillaries within a single fibre. In such an embodiment, the capillaries are substantially a plurality of pores running through the length of the fibre. Although not essential, the capillaries may be substantially parallel with the longitudinal axis of the fibre. The fibre may be of a substantially uniform material (e.g., a matrix) such as, for example, a silica-based material like glass, or a polymeric material such as a plastic or polycarbonate, such that there is matrix material and no air space between capillaries.

The number of capillaries in the array may range from, for example, 3 to 10,000, from 3 to 1000, or from 3 to 100, depending on the analyte, the desired flow rate, etc. The inside diameter of each capillary may be from 50 nm to 50 μm, from 500 nm to 10 μm, or from 1 μm to 8 μm, for example, 4 μm to 5 μm, depending on the analyte, the analyte volume and concentration, the desired flow rate, the number of capillaries, etc. The inside diameter of the capillaries may be the same, or may be different.

One embodiment relates to a microreactor array based on a microstructured fibre (MSF). The MSF includes a plurality of capillaries, each of which may be used as microreactor. The number of capillaries in the MSF may range from 3 to 10,000, from 3 to 1000, or from 3 to 100, or fewer, depending on factors such as, for example, the analyte volume and concentration, the desired flow rate, etc. The inside diameter of each capillary may be the same or different, and may be from 50 nm to 50 μm, from 500 nm to 10 μm, or from 1 μm to 8 μm, for example, 4 μm to 5 μm, depending on factors such as, for example, the analyte, the analyte volume and concentration, the desired flow rate, the number of capillaries, etc.

An example of a MSF that is commercially available is a photonic crystal fibre (PCF). PCFs are commonly used for guiding light in optical applications. A PCF is essentially an optical fibre (usually made of silica and having an outer coating or cladding made of an acrylate-based polymer) having a plurality of microscopic capillaries running along the entire length of the fibre. In optical applications, light is confined to either a solid or hollow core through periodic refractive index changes. The refractive index changes are developed through the capillaries that run throughout the length of the fibre. In optical applications PCFs have superior performance relative to conventional optical fibres, mainly because they permit low loss guidance of light in a hollow core. PCFs have also been used in various non-optical applications (see Russel, P. S. J., Science 2003, 299, 358-362), including microchip electrophoresis (Sun, Y., et al., Electroporesis 2007, 28, 4765-4768); however, none of those applications relates to microreactors.

The inventors believe that they are the first to use these fibres as microreactors. The capillaries of the fibre are modified (i.e., functionalized) with one or more reagents to produce, enhance, and/or effect chemical reactions in the capillaries as a fluid sample is passed through. The PCF fibres offer substantial surface to volume ratios and provide a basis to efficiently transport fluid samples and effect chemical reactions. Further, the fibres offer significantly lower backpressures (i.e., resistance to fluid flow) than conventional “packed” microreactors. In general, a microreactor array as exemplified by the embodiments described herein is easily produced, inexpensive, long lasting, and able to resist clogging.

The inner walls of the capillaries of the microreactor may be modified (i.e., functionalized) with a surface derivatization and reagent coupling scheme, such as, for example, chloro- or triethoxysilane, n-hydroxysuccinamide, or carbodiimide, so that reagents, such as, for example, enzymes, catalysts, etc., may be attached. Functionalizing may include one or more chemical moieties, such as, for example, chloromethylsilane or trimethoxy-based acrylate (Gottschlich, et al., Anal. Chem. 2001, 73, 2669-2674). Surface modification may also include treatment with compounds of the type such as, for example, C(OR)₄ (orthocarbonates), R′C(OR)₃ (orthoesters), and R′R″C(OR)₂ (acetals and ketals). For R′C(OR)₃ compounds, examples of R′ include, but are not limited to H, Me, Et, Bu, Pr, and Ph, and examples of R include, but are not limited to, Me, Et, Bu, and Ph. For R′R″C(OR)₂ compounds, examples of R′ include, but are not limited to, H and Me, and examples of R″ include, but are not limited to, H, Me, CH₂CN, CH₂COMe, and p-C₆H₄COH, where R is Me or Et. For further details, see Guidotti, et al., J. Colloid Interface Sci. 1997, 191, 209-215. Other functionalizing agents may of course be used, as required for specific reagents and/or analytes. For example, the following solvents may be used in either a single component or multi-component mixture: water, ethanol, methanol, acetonitrile, acetone, buffers, detergents, and the like.

Use of MSFs results in substantially lower backpressures (resistance to fluidic flow) compared to conventional capillary reactors packed with particulate stationary phase materials such as PPM. Thus, use of an MSF for a microreactor is expected to increase efficiency as well as obviate the need for high pressure pumping. A benefit of the lower back pressure is the possibility of using longer capillaries, which improves reactor efficiency and enables the use of smaller, less expensive pumping systems.

It will be appreciated that a plurality of individual capillaries, rather than an MSF, may also be used for a microreactor array. In such an embodiment, the individual capillaries may be bundled together and connected to apparatus (e.g., a pump) for delivering the analyte solution to the capillaries. This may be accomplished by, for example, connecting each capillary to a manifold which is connected to the pump. However, such an arrangement may be difficult and time-consuming to set up for system having many capillaries. Alternatively, the capillaries may be bundled together and connected to the pump as a single unit. However, a proper connection may be difficult to achieve because of the resulting spaces between capillaries in the bundle. Use of a MSF, such as a PCF, as described herein, overcomes these difficulties because, as described above, the MSF lacks spaces between capillaries. Thus, a proper connection of the MSF to the pump may be readily achieved via a single connection.

A microreactor array as described herein may be used for both liquid and gas samples. Also, a microreactor may be used in an on-line fashion, for example, prior to mass spectrometry analysis. Further, the microreactor may itself be used as also a nanoelectrospray emitter, combining the two functions in a single unit. Use of the microreactor as a nanoelectrospray emitter requires applying a potential difference to the microreactor.

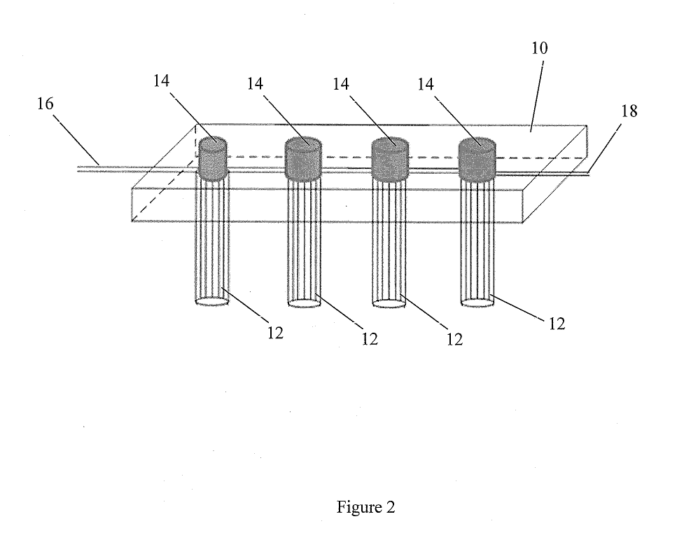

Also described herein is a microreactor array system, comprising two or more microreactor arrays as described above. An embodiment is shown in FIG. 2. Referring to FIG. 2, a microreactor array system may include a manifold 10 that holds microreactor arrays 12. Once the microreactor arrays are installed in the manifold 10, a proximal end of each microreactor array 12 is fitted with a port 14. The ports 14 are connected to a solvent and/or sample delivery conduit 16. Each microreactor array 12 has one or more reagent (e.g., a catalyst or enzyme) as described above. The microreactor arrays 12 may all have the same one or more reagent, or they may have different reagents. Prior to being installed in the manifold 10, each microreactor array 12 may be preloaded with a sample (i.e., a reactant such as a protein). Alternatively, a sample may be delivered to the microreactor arrays 12 via the sample and/or solvent delivery conduit 16. Compounds and/or materials of interest in the sample may react and/or be digested in the microreactor arrays 12, and the products and/or digests may be obtained in collectors (not shown) located at distal ends of the microreactor arrays 12. A solvent may be delivered to the microreactor arrays 12 via the sample and/or solvent conduit 16, to remove products and/or digests from the microreactor arrays 12. A waste conduit 18 may be provided to remove excess sample and/or solvent. Although not shown, a pump may be located at the delivery conduit 16 to apply the sample and/or solvents to the ports 14 and microreactor arrays 12

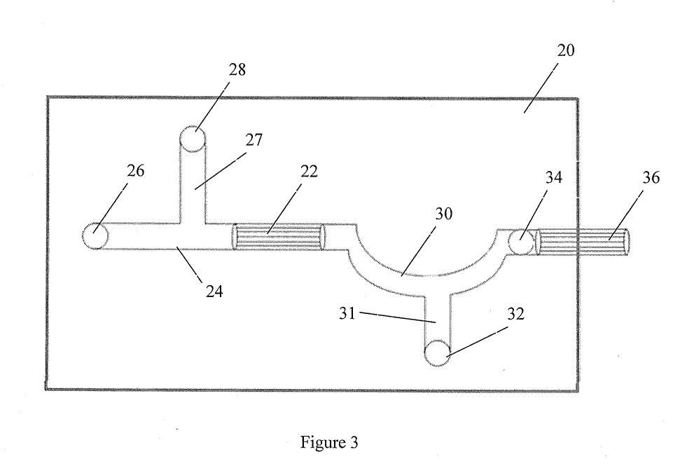

Also described herein is a microreactor array system in microchip format, comprising at least one microreactor array as described above. An embodiment is shown in FIG. 3. Referring to FIG. 3, the system includes a microchip substrate 20 made of a suitable material such as plastic or silica (e.g., glass). Substantially or partially embedded in the microchip 20 is one or more microreactor array 22. A sample transfer channel 24 is at least partially formed in the microchip substrate 20 and is connected to a proximal end of the microreactor array 22. The sample transfer channel 24 has a port 26 by which a sample is introduced into the system. Connected to the sample transfer channel 24 is a solvent transfer channel 27, which has a port 28 by which one or more solvent is introduced into the system. The microreactor array 22 has one or more reagent (e.g., a catalyst and/or enzyme) as described above. The output of the microreactor array 22 (products and/or digests) may then be collected by providing a suitable collection channel or reservoir at the distal end of the array 22. In embodiments where products and/or digests of the microreactor array 22 are to be subjected to mass spectrometry (MS), the distal end of the array 22 may be connected to a reservoir channel 30, to which an electrospray ionization (ESI) solvent transfer channel 31 is connected. The ESI solvent transfer channel 31 may have a port 32 by which an ESI solvent may be introduced. A fourth port 34 including an electrode may be provided at a distal end of the reservoir 30, for connecting a voltage source for ESI. After the port 34, an ESI emitter 36 may be provided so as to deliver the products and/or digests directly to the MS ion source.

The invention will be further described by way of the following non-limiting example.

### WORKING EXAMPLE

The following example describes the preparation of a microreactor array from a MSF, and use of the microreactor array for cytochrome c digestion.

A 10 cm length of PCF, FC-20 MSF, available from Crystal Fibre, having 168 capillaries (≈5.6 micron hole diameter, 168 holes,) was functionalized with trypsin as follows.

A solution of 20% (v/v) (3-aminopropyl)triethoxysilane, 50% (v/v) water (18.2 MΩ), and 30% (v/v) acetic acid was passed through the MSF at 1 μL/min for 3.5 h using a syringe pump. Then a solution of 0.1 M sodium phosphate buffer (pH 7.0) with 2.5% gluteraldehyde was passed through the MSF at 1 μL/min for 5 h using a syringe pump. Finally, a solution of 4 mg/mL trypsin in 0.1 M sodium phosphate buffer, with 0.1% sodium cyanoborohydride (to suppress reversibility of Schiff base formation and to stabilize the bound enzyme) was passed through the MSF at 0.5 μL/min overnight using a syringe pump.

For cytochrome c digestion, 10 μL of a 1 mg/mL cytochrome c solution, 990 μL of 50 mM ammonium bicarbonate, and 600 μL of methanol were mixed and passed through a 10 cm length of the trypsin functionalized MSF at 0.5 μL/min using a syringe pump, and the resulting solution was collected. A dihydroxybenzoic acid (DHB) solution was prepared from 20 mg/mL DHB in 33% acetonitrile and 67% water (18.2 MΩ). An analyte solution was prepared by mixing the collected solution with the DHB solution in a 1:2 ratio, and analyzed on a MALDI-TOF mass spectrometer (QSTAR XL) using the dried drop matrix preparation method.

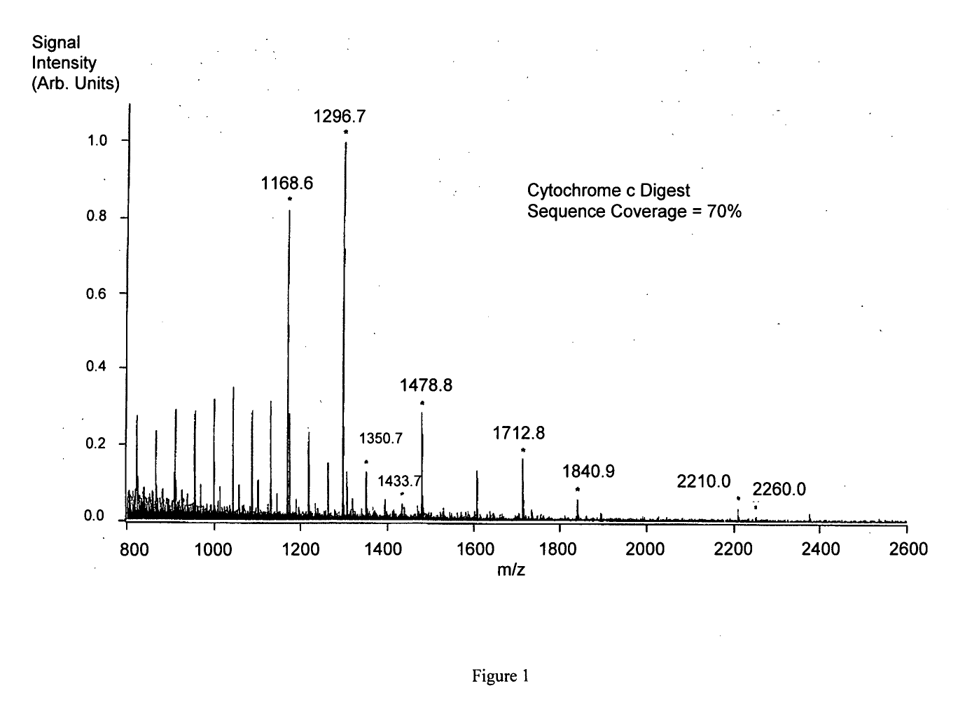

The MS plot is shown in FIG. 1, where cytochrome c digestion resulted in a sequence coverage of about 70%, with two missed cleavages.

All cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

1. A microreactor array, comprising:
a single fibre comprising a matrix material;
a plurality of capillaries formed within the matrix material, the capillaries substantially aligned along a longitudinal axis of the fibre; and
one or more reagent associated with an inner surface of the capillaries;
wherein each capillary corresponds to a microreactor of the array.

2. The microreactor array of claim 1, wherein the capillaries are arranged in a substantially parallel relationship within the fibre.

3. The microreactor array of claim 1, wherein the fibre is a microstructured fibre.

4. The microreactor array of claim 3, wherein the fibre is a photonic crystal fibre.

5. The microreactor array of claim 1, wherein the reagent comprises at least one enzyme.

6. The microreactor array of claim 1, wherein the reagent comprises at least one catalyst.

7. A microreactor array system, comprising the microreactor array of claim 1 and a pump for applying a fluid sample to the array.

8. The microreactor array system of claim 7, further comprising a source of potential difference, wherein the microreactor array is used as a nanoelectrospray emitter.

9. A method of carrying out a chemical reaction, comprising:
providing a single fibre comprising a matrix material and a plurality of capillaries formed within the matrix material, the capillaries substantially aligned along a longitudinal axis of the fibre, wherein each capillary is a microreactor;
providing one or more reagent associated with an inner surface of the capillaries; and
applying a fluid sample to the capillaries;
wherein one or more components of the fluid sample react with the reagent in the capillaries of the fibre.

10. The method of claim 9, wherein the fibre comprises a microstructured fibre.

11. The method of claim 9, wherein the fibre comprises a photonic crystal fibre.

12. The method of claim 9, wherein the reagent comprises at least one enzyme.

13. The method of claim 9, wherein the reagent comprises at least one catalyst.

14. The method of claim 9, further comprising applying a potential difference to the microreactor, and producing from the microreactor a nanoelectrospray of the sample.

15. A microreactor array system, comprising;
a manifold that holds at least two microreactor arrays of claim 1;
at least two said microreactor arrays;
a delivery conduit connected to each microreactor array; and
a waste conduit connected to each microreactor array.

16. The microreactor array system of claim 15, further comprising a collector associated with each microreactor array.

17. The microreactor array system of claim 15, further comprising a pump for delivering a sample and/or solvent to the microreactor arrays via the delivery conduit.

18. A microreactor array system microchip, comprising:
a substrate;
at least one microreactor array of claim 1 at least partially embedded in the substrate;
a sample delivery channel in communication with a proximal end of the microreactor array and at least partially formed in the substrate, for delivering a sample to the microreactor array;
a solvent delivery channel in communication with a proximal end of the microreactor array and at least partially formed in the substrate, for delivering a solvent to the microreactor array;
a reservoir in communication with a distal end of the microreactor array and at least partially formed in the substrate, for receiving products and/or digests of a reaction and/or digestion carried out in the microreactor array;
an electrospray solvent delivery channel in communication with the reservoir and at least partially formed in the substrate, for delivering an electrospray solvent;
an electrospray emitter in communication with a distal end of the reservoir and at least partially embedded in the substrate; and
an electrode at a distal end of the reservoir, for applying a voltage to the emitter;
wherein the emitter produces an electrospray.

19. The microreactor array system microchip of claim 18, wherein the electrospray emitter is a microstructured fiber (MSF) electrospray emitter.
